(19) United States
(12) Patent Application Publication
(10) Pub. No.: US 2005/0025095 A1
(43) Pub. Date: Feb. 3, 2005

(54) Access method of a mobile station for extending cell service range and a method for serving an extended range cell in a mobile communication system

(75) Inventor: Hoe-Won Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/818,416

(22) Filed: Apr. 5, 2004

(30) Foreign Application Priority Data
Jul. 31, 2003 (KR) 2003-53269

(51) Int. Cl. H04Q 7/00; H04B 7/212; H04J 3/00

(52) U.S. Cl. 370/329; 370/336; 370/347

(57) ABSTRACT

A method for a mobile station (MS) to access a base transceiver station (BTS) for a first time in order to extend a cell service range of the BTS in a mobile communication system employing a time division multiple access, wherein the MS (1) receives extended range cell system information from the BTS, which includes position information of the BTS and information reporting a fact that the MS is located in an extended range cell; (2) computes a distance from the BTS by means of the position information of the BTS and position information of the MS itself; and (3) computes an estimated extended timing advance (ETA) by means of the computed distance from the BTS, processing the estimated ETA by means of a predetermined value for considering an error, and generates an initial extended timing advance (IETA).

This application claims priority to an application entitled “Access Method of Mobile Station for Extending Cell Service Range and Method for Serving Extended Range Cell in Mobile Communication System” filed in the Korean Industrial Property Office on Jul. 31, 2003 and assigned Serial No. 2003-53269, the contents of which are hereby incorporated by reference.

### BACKGROUND OF THE INVENTION

1. Field of the Invention

The present invention relates generally to a mobile communication system, more particularly to a method for serving an extended range cell in a global system for mobile communication (GSM) system.

2. Description of the Related Art

FIG. 1 is a block diagram illustrating a GSM-type mobile communication system. The mobile communication system includes base transceiver stations (BTS) 20 and 22. The BTSs 20 and 22 are connected to a base station controller (BSC) 30. Further, the BTSs 20 and 22 are connected to mobile stations (MS) 10 and 12 in corresponding cell ranges C1 and C2, in a wireless manner, and they provide a mobile communication service. The BSC 30 is connected to a mobile telephone switching center (MSC) 40. A service node (SN) 50 is connected to the MSC 40 and supports a predetermined service with respect to the mobile communication system.

As illustrated in FIG. 1, because the MS 10 is located in the cell C1, a mobile communication service is provided by the BTS 20 with respect to a predetermined wireless channel by means of time division multiple access (TDMA) concept. A physical wireless interface is divided according to a TDMA structure, that is, a wireless carrier is divided to time slots. A frame includes eight continuous time slots. Herein, when connection is performed, an MS uses a physical channel, which includes one time slot per a frame, with respect to each uplink and downlink.

FIG. 2 is a graph illustrating a burst transmission timing in a mobile communication system and FIG. 3 is a view illustrating a TDMA frame including a time slot. In detail, FIG. 3a illustrates a normal burst and FIG. 3b illustrates an access burst.

A GSM-type MS communicates with a BTS through a predetermined time slot. As illustrated in FIG. 2, 542.8 μs are assigned to each time slot for data transmission. Such a short period accommodates 147 data bits. Actually, each time slot includes 148 bits, but a first half-bit and a last half-bit are provided for on/off RF switching time. Each time slot includes burst-type data.

As illustrated in FIG. 3, the normal burst and the access burst includes various bits. The normal burst is used for transmitting information on any traffic channel or any control channel, except for a random access channel (RACH). In a normal burst, a stealing flag represents whether a burst has been used for a fact associated control channel (FACCH) signaling, and a training sequence is 26 bits pattern used for compensating for a multi-path propagation. Further, in the normal burst, a tail bit (T) represents a start and a stop of a bit pattern, and a guard period (GP) is an empty portion and protects an overlapping with other time slots. Further, the access burst is used when an MS connects to a BTS either for the first time or in a handover region. Because the access burst does not understand propagation delay time when an MS connects to a mobile communication system for the first time, it has a GP longer than that of a normal burst for burst transmission.

More specifically, only when the MS does not have effective information for current propagation delay in a corresponding cell, the access burst is used in the uplink direction. Accordingly, the access burst has a shorter length so as to be fit into each receiving window in a BTS. That is, a signal burst from the MS must be received in a time slot reserved in the BTS.

FIG. 4 is a view illustrating a timing delay in a mobile communication system. As illustrated in FIG. 4, when a BTS transmits a burst signal in FIG. 4a to an MS, the MS receives a burst signal as illustrated in FIG. 4b due to propagation delay, that is, a timing delay (TD), between the BTS and the MS. Accordingly, the MS must uplink the burst signal in advance by a timing advance (TA) as illustrated in FIG. 4c, so that the burst signal can be received in a time slot reserved in the BTS. Then, the BTS can almost accurately receive the burst signal in a time slot reserved for the MS. The TA is obtained by multiplying TA from the BTS to the MS by two. That is, because the MS receives a burst signal delayed by TD from the BTS, received timing is timing having TD from the BTS. Accordingly, in order for a burst signal to be received in a time slot in a BTS, which is assigned to a corresponding MS, the MS must transmit the burst signal in advance by the TA, that is, TD×2 considering both a TD in downlink and a TD in uplink.

As described above, because the MS can accurately transmit a burst signal to a BTS only when it understands TA, the MS uplinks an access burst with a TA of zero when it accesses to the BTS for the first time. As illustrated in FIG. 3, because the access burst has a large GP, which is an empty portion, the BTS can obtain information, which enables the BTS to compute the TA value without having an influence on other channels.

Herein, in a case of a GSM-type mobile communication system, the TA has a maximum value of 63 bits and the maximum value is related to GP of AB. Because this 63 bits is a time delay corresponding to 70 km, a cell range having a 35 km radius may be covered.

FIG. 5 is a view illustrating timing delay according to distance in the existing GSM-type mobile communication system. FIG. 5 illustrates how much an access burst is delayed according to distance between an MS and a BTS when it is received by the BTS from the MS. In FIG. 5, the front half of the access burst represents data such as synchronization sequence and coded data as illustrated in FIG. 3, and the rear half of the access burst represents a GP, which is an empty portion. When distance between the MS and the BTS is 0 km, the access burst from the MS is almost accurately received in a time slot, which is assigned to a corresponding MS, in the BTS (FIG. 5a). When distance between the MS and the BTS is 35 km, a GP, which is an empty portion in the access burst from the MS, is overlapped from a time slot, which is assigned to a corresponding MS, to other time slots, that is, other channels, in a BTS (FIG. 5b). In this case, because the GP does not influence other channels, the BTS can compute a TA when it receives an access burst from an MS within maximum of 35 km. However, when the distance between the MS and the BTS exceeds 35 km, the access burst from the MS is received in a time slot reserved for other MSs, and therefore the BTS cannot provide mobile communication services to MSs (FIGS. 5c and 5d).

As descried above, in a GSM-type mobile communication system, because a BTS provides mobile communication services to MSs located in a predetermined range, MSs deviating from the predetermined range cannot receive the mobile communication services. In order to solve this problem, a BTS can be installed according to a predetermined range and this is suitable for a region having many subscribers such as a city. However, this results in a waste of wireless resources in a region, which has almost no subscribers.

### SUMMARY OF THE INVENTION

Accordingly, the present invention has been designed to solve the above and other problems occurring in the prior art, and a primary object of the present invention is to provide a method of a mobile station accessing to a base transceiver station for a first time in order to extend a mobile communication service range of the base transceiver station in a mobile communication system employing a time division multiple access.

Another object of the present invention is to provide a method for serving an extended range cell in a mobile communication system employing a time division multiple access.

In order to accomplish the above and other objects, according to an embodiment of the present, there is provided a method of an MS for accessing a BTS for a first time in order to extend a cell service range of the BTS in a mobile communication system employing a time division multiple access, the method comprising the steps of: (1) receiving extended range cell system information from the BTS, which includes position information of the BTS and information reporting a fact that the MS is located in an extended range cell; (2) computing distance from the BTS by means of the position information of the BTS and position information of the MS itself, and (3) computing an estimated ETA by means of the computed distance from the BTS, processing the estimated ETA by means of a predetermined value for considering an error, and generating an IETA.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating a GSM-type mobile communication system;

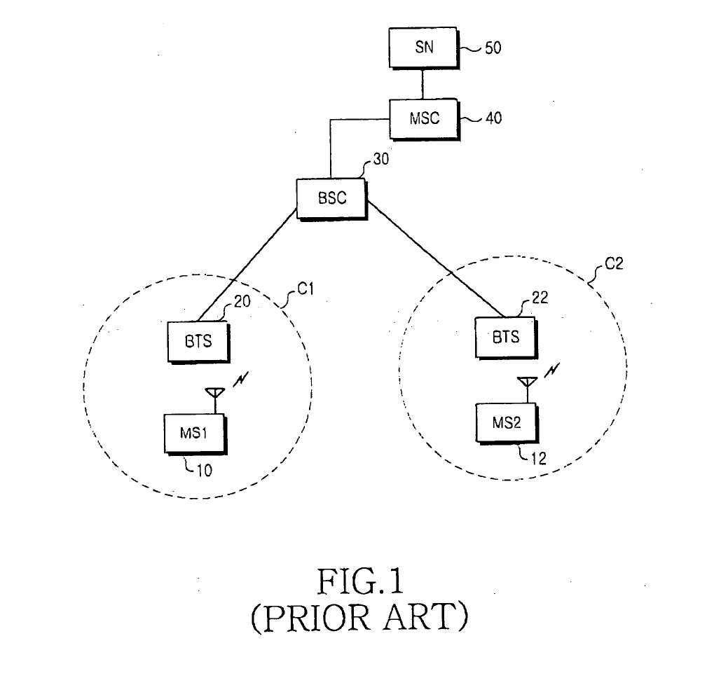

FIG. 2 is a graph illustrating burst transmission timing in a mobile communication system;

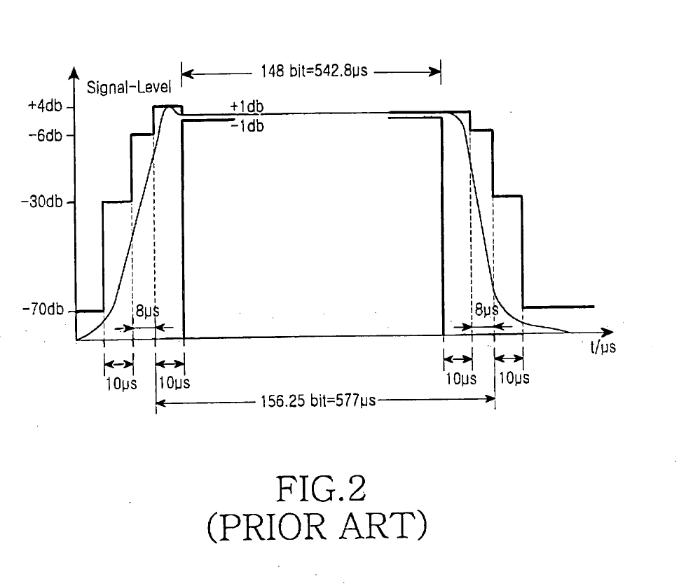

FIG. 3 is a view illustrating a TDMA frame including a time slot;

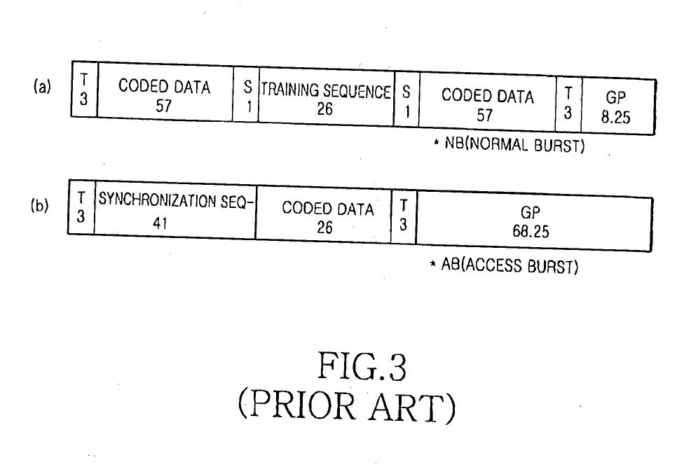

FIG. 4 is a view illustrating a timing delay in a mobile communication system;

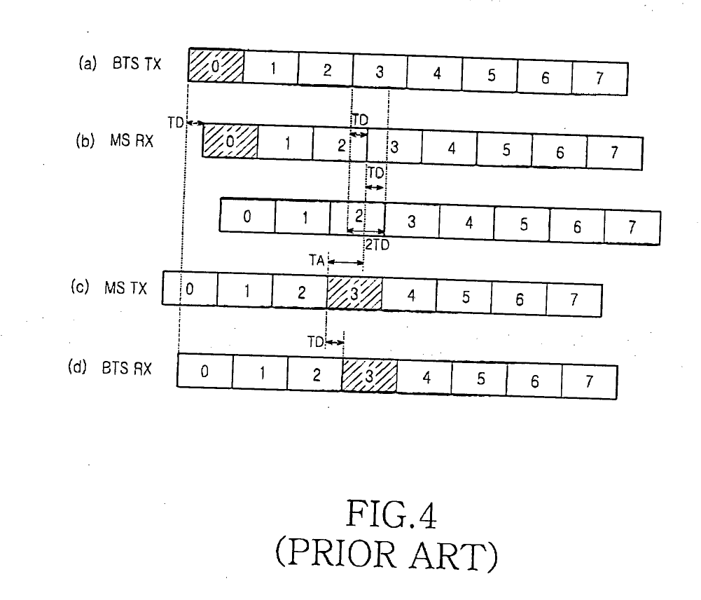

FIG. 5 is a view illustrating a timing delay according to distance in the existing GSM-type mobile communication system;

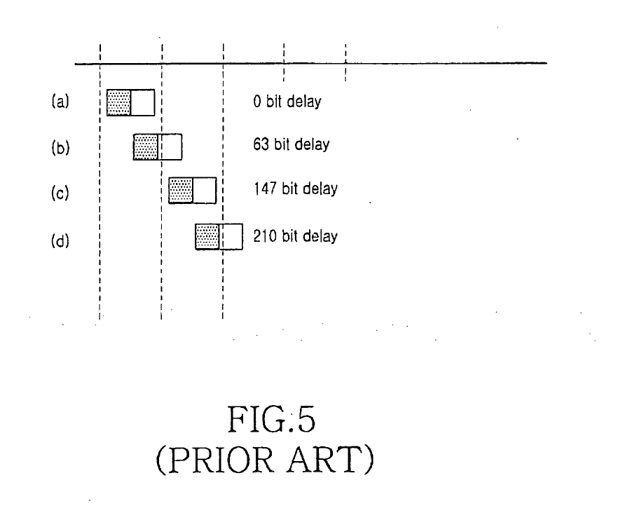

FIG. 6 is a view illustrating a mobile communication system and an extended cell service range thereof according to the present invention;

FIG. 7 is a flowchart illustrating a method for serving an extended range cell according to the present invention;

FIG. 8 is a view illustrating a burst signal transmitted between a mobile station and a base transceiver station according to an estimated ETA obtained by the present invention; and

FIG. 9 is a view illustrating a burst signal transmitted between a mobile station and a base transceiver station according to initial extended timing advance (IETA) obtained by the present invention.

### DETAILED DESCRIPTION OF THE PREFERRED EMBODIMENT

Preferred embodiments of the present invention will be described in detail herein below with reference to the accompanying drawings. In the following description of the present invention, a detailed description of known functions and configuration incorporated herein will be omitted when it may make the subject matter of the present invention rather unclear.

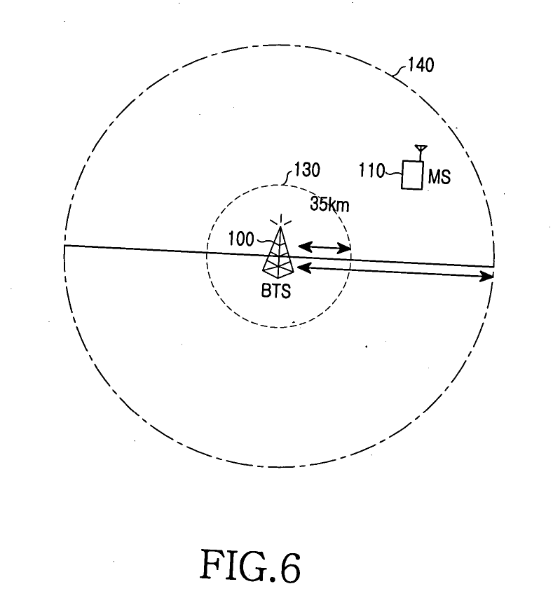

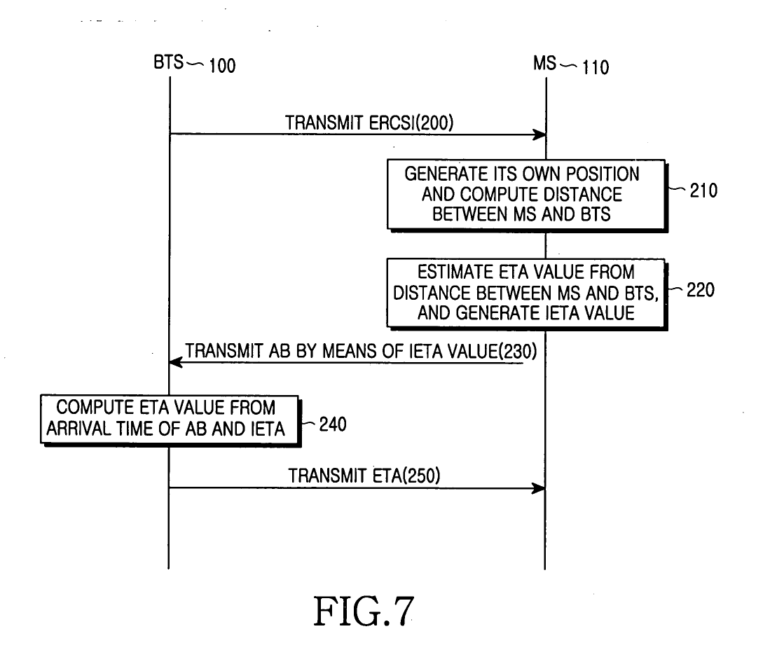

FIG. 6 is a view illustrating a mobile communication system and an extended cell service range thereof according to the present invention and FIG. 7 is a flowchart illustrating a method for serving an extended range cell according to the present invention.

As illustrated in FIG. 6, a cell range 140 covered by a base transceiver station (BTS) 100 according to the present invention extends farther than an existing range (dotted line) 130. This is called an extended range cell 140. The BTS 100 must understand that a range served by the BTS 100 itself is wider than a general cell range 130. That is, in order to communicate with a mobile station (MS) 110 located away from the general cell range 130, the BTS 100 increases power. Accordingly, the BTS 100 must be designed so as to serve the extended range cell from its installation.

Hereinafter, a method for serving an extended range cell according to the present invention will be described with reference to FIG. 7. First, in step 200, the BTS 100 provides extended range cell system information (ERCSI) to an MS 110 in the extended range cell. The MS 110 in the extended range cell can communicate with the BTS 100 only when the MS 110 understands that the MS 110 itself is located in the extended range cell. The ERCSI includes information for reporting the fact that the MS 110 is located in the extended range cell, and also position information of the BTS 100. The position information of the BTS 100 is geometrical position information. Because a position of the BTS 100 is fixed when it is installed, the BTS 100 can easily understand its own geometrical position information. For example, the geometrical position information may be a latitude and a longitude of a position in which the BTS 100 is located.

When the MS 110 receives the ERCSI from the BTS 100, the MS 110 recognizes the fact that the MS 110 is located in the extended range cell. Position information of the MS 110 is measured with accuracy of such a wide range as from several meters to several kilometers according to measurement methods, and more accurate measurement will be possible in the near future. Position measurement methods include an enhanced observed time difference (E-OTD), a global positioning system (GPS), an assisted-GPS (A-GPS), a differential-GPS (DGPS), and an uplink time of arrival (UL-TOA). Such position information is also used in location services (LCS). The LCS represents a service and a system for the service, in which a position of a human or an object can be accurately understood on the basis of an MS and additional information relating to the position can be provided. Herein, an extended range cell service may be performed on the basis of such LCS.

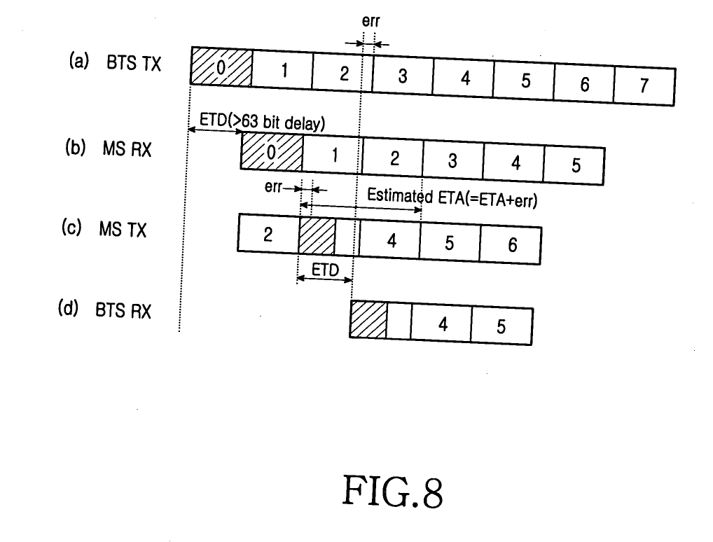

In step 210, the MS 110 recognizes its own position by means of the aforementioned various methods and computes distance between the MS 110 and the BTS 100 by means of its own position and the position of the BTS 100 provided from the BTS 100. Further, in step 220, the MS 110 estimates an extended timing advance (ETA) from distance between the MS 110 and the BTS 100. That is, by means of the distance between the MS 110 and the BTS 100, the MS 110 estimates how much in advance a burst signal should be transmitted so that the burst signal can be received in the reserved time slot for a corresponding MS in the BTS 100. Further, the MS 110 processes the estimated ETA by means of a predetermined value and generates initial extended timing advance (IETA). This predetermined value is for considering difference between the estimated ETA and an actual ETA. That is, the estimated ETA may be different from the actual ETA, and the difference is called an estimation error. For example, the estimated error value may be 32 bits, which is half of maximum TA, in an access burst. Accordingly, in the present embodiment, the IETA has a value of estimated ETA, which is half of maximum TA. Such an estimated error will be described with reference to FIG. 8.

FIG. 8 is a view illustrating a burst signal transmitted between an MS and a BTS according to an estimated ETA obtained by the present invention. As described above, the MS 110 estimates an ETA by means of its own position information and position information of a BTS and transmits an access burst to the BTS 100 by means of the estimated ETA. This estimated ETA is two times of an extended timing delay (ETD) between the BTS 100 and the MS 110. As described above, the ETA is computed by means of position information of the MS 110 and the position information has accuracy of such a wide range as from several meters to several kilometers. Accordingly, because the MS 110 computes the ETA by means of position information having a predetermined error, the computed ETA has an estimated error.

Referring to FIG. 8, when the BTS 100 transmits a burst signal (FIG. 8a), the MS 110 receives the burst signal delayed by the ETD (FIG. 8b). Herein, when the MS 110 actually transmits the access burst to the BTS 100 by means of the estimated ETA (FIG. 8c), because the estimated ETA has a difference from an actual ETA, a burst signal received by the BTS is deviated from a time slot, in which the burst signal must be received, by such a difference (FIG. 8d). For example, when the estimated ETA goes ahead of the actual ETA due to the estimated error, effective data in a front portion in the burst signal received by the BTS may be lost.

Accordingly, in the present invention, the MS 110 generates the IETA from the estimated ETA in consideration of difference between the estimated ETA and the actual ETA, as described above.

Herein, referring to FIG. 7, the MS 110 transmits the access burst to the BTS 100 by means of a value of the IETA in step 230. Then, in step 240, the BTS 100 computes a value of the actual ETA from arrival time of the access burst and the IETA, which are transmitted from the MS 110. In the present embodiment, the actual ETA is expressed by Equation (1).
ETA=IETA(estimated ETA−maximum TA/2)+measured TD Equation (1)

In step 250, the BTS 100 transmits the actual ETA to the MS 110. Therefore, the MS 110 accesses an uplink channel, which is assigned from the BTS 100, by means of the actual ETA transmitted from the BTS 100.

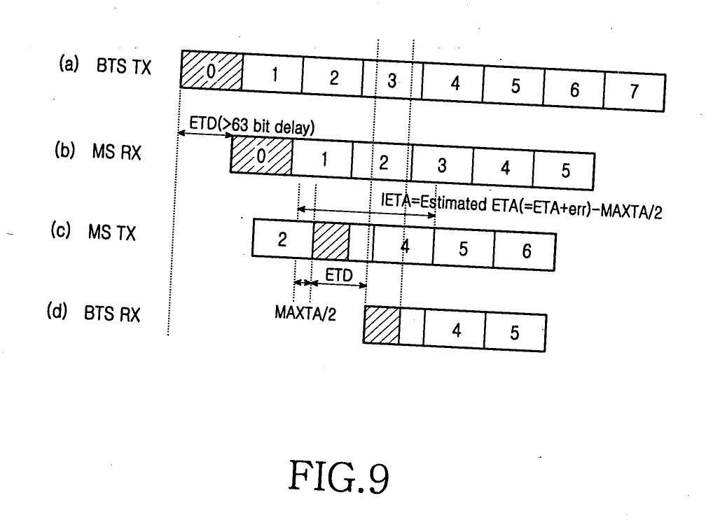

FIG. 9 is a view illustrating a burst signal transmitted between an MS and a BTs according to IETA obtained by the present invention. Referring to FIG. 9, when the BTS 100 transmits a burst signal (FIG. 9a), the MS 110 receives the burst signal delayed by the ETD (FIG. 9b). Further, when the MS 110 transmits an access burst to the BTS 100 by means of IETA considering an estimated error (FIG. 9c), the IETA causes an estimated ETA to lag by the estimated error, thereby preventing effective data in a front portion in the burst signal from being lost (FIG. 9d).

According to the present invention, in a GSM-type mobile communication system, a TA is computed by means of position information of a BTS and position information of an MS, thereby extending a mobile communication service range of the BTS.

While the present invention has been illustrated and described with reference to certain preferred embodiments thereof, it will be understood by those skilled in the art that various changes in form and details may be made therein without departing from the spirit and scope of the invention as defined by the appended claims.

1. A method a in a mobile station (MS) for accessing to a base transceiver station (BTS) for a first time in order to extend a cell service range of the BTS in a mobile communication system employing a time division multiple access, the method comprising the steps of:
(1) receiving extended range cell system information from the BTS, which includes position information of the BTS and information indicating that the MS is located in an extended range cell;
(2) computing a distance from the BTS by means of the position information of the BTS and position information of the MS; and
(3) computing an estimated extended timing advance (ETA) by means of the computed distance from the BTS, processing the estimated ETA by means of a predetermined value for considering an error, and generating an initial extended timing advance (IETA).

2. The method as claimed in claim 1, further comprising the step of (4) transmitting an access burst to the BTS by means of the IETA.

3. The method as claimed in claim 2, wherein the BTS computes an arrival time of an access burst from the MS and an actual ETA from the IETA and transmits the computed result to the MS.

4. A method for serving an extended range cell of a base transceiver station (BTS) in a mobile communication system employing a time division multiple access, the method comprising the steps of:
(1) transmitting extended range cell system information, which includes position information of the BTS and information reporting that a mobile station (MS) is located in an extended range cell, from the BTS to the MS;
(2) when the MS receives the extended range cell system information, computing, by the MS, a distance from the BTS by means of the position information of the BTS and position information of the MS itself;
(3) computing, by the MS, an estimated extended timing advance (ETA) by means of the computed distance from the BTS, processing the estimated ETA by means of a predetermined value for considering an error, and generating an initial extended timing advance (IETA);
(4) transmitting an access burst from the MS to the BTS by means of the IETA; and
(5) computing, by the BTS, an arrival time of the access burst from the MS and an actual ETA from the IETA, and transmitting the computed result to the MS.

5. The method as claimed in claim 4, further comprising the step of (6) accessing, by the MS, the BTS by means of the actual ETA from the BTS.
